(19) United States
(12) Patent Application Publication
(10) Pub. No.: US 2010/0242177 A1
(43) Pub. Date: Sep. 30, 2010

(54) Padded patient immobilizer for surgery tables

(75) Inventors: Roger J. Malcolm, Capistrano Beach, CA (US); Robert D. Allen, Newbury, OH (US); Timothy M. Salter, Silverado Canyon, CA (US); Emilio J. Aguilar, Mission Viejo, CA (US)

Correspondence Address: CHARMASSON, BUCHACA & LEACH, LLP, 2635 Camino Del Rio South, Suite 102, SAN DIEGO, CA, 92108, US

(73) Assignee: COMPOSITE MANUFACTURING, INC., San Clemente, CA (US)

(21) Appl. No.: 12/570,788

(22) Filed: Sep. 30, 2009

Related U.S. Application Data
(60) Provisional application No. 61/101,526, filed on Sep. 30, 2008.

(51) Int. Cl. A61G 13/12

(52) U.S. Cl. 5/621

(57) ABSTRACT

A device for restraining the movement of a body lying over the top surface of a tiltable treatment table comprises a yoke spanning said top surface and being secured at both ends to an accessory-mounting rail running along the side of the table. The yoke includes a channel into which rides a shuttle. An angled support bracket has a vertical leg mounting a padded barrier, and a horizontal plate attached to the shuttle across a slot in the channel. The translation of the barrier, support bracket and shuttle along the channel, and the orientation of the barrier can be adjusted and locked in place by a single knobbed tightening screw. A neck support is secured over a median portion of the yoke. The device may be used by placing one or more of the padded barriers against the shoulders, hips, feet or the head of a patient lying in the Trendelenburg or other tilted position on an operating table in order to prevent gravity-induced shift of the body.

### PRIOR APPLICATION

This application claims the benefit of U.S. Provisional Utility Patent Application Ser. No. 61/101,526 filed 2008-09-30.

### FIELD OF THE INVENTION

This invention relates to medical treatment tables and their accessories, and particularly to devices used to support and immobilize the whole or part of a patient's anatomy during surgery or other treatment on a tiltable table.

### BACKGROUND

Surgical and other medical treatment tables are often provided with bracing and immobilizing accessories used to restrain the movement of the whole or part of a patient's body particularly under conditions where the body support table is tilted in a Trendelenburg or other longitudinal or lateral position in order to provide more convenient or comfortable access to part of the patent's anatomy. Some examples of this type of bracing and restraining devices are disclosed in U.S. Pat. No. 5,090,073 Nordan et al. and U.S. Pat. No. 6,622,324 Van Steenburg et. al., both of which are incorporated herein by this reference, the latter being the most advanced representation of the current state of the art. In that most recent example, the padded barriers that are applied against the patient's body are held by one or more elongated arms whose opposite ends are secured to accessories-mounting rails running along the sides of the operating table. Due to their relative lengths these elongated arms act as levers subject to considerable torquing forces. These forces have a negative impact on the stability of the structure and contribute to rapid wear of the locking components. The adjustment of the positions of the various padded barriers typically requires time-consuming manipulation of a number of knobs and levers and necessitates the use of both hands. The length, bulkiness and complexity of the bracing and restraining structures will often interfere with the physician's access to the body and with the cables, conducts and controls for life support and/or other peripheral equipment.

The instant invention results from an attempt to provide a more sturdy, yet compact bracing and restraining device that can be quickly and accurately positioned on a surgical or other form of treatment table and adjusted single-handedly.

### SUMMARY

The principal and secondary objects of the invention are to provide an improved bracing device. These and other objects are achieved by an adjustable barrier according to the invention.

In some embodiments there is provided, in association with a medical treatment table, an accessory for bracing or restraining the movement of a patient's body lying over the top surface of the table comprises a yoke transversally spanning said top surface and being secured at both ends to accessory-mounting rails running along the side of the table. In some embodiments the yoke includes a track or channel extending horizontally over said top surface and a shuttle engaged in the track or channel. In some embodiments a carriage in the form of an angled bracket has an horizontal plate releasably secured to the shuttle by a single knobbed screw, and a vertical arm mounting a padded barrier. In some embodiments by manipulation of the knobbed screw, the carriage and barrier can be adjustably translated along lengths of the track or channel and immobilized in a particular orientation that places the padded barrier against a part of the body. In some embodiments multiple barriers can be so mounted along the track or channel. In some embodiments a headrest is secured to the top surface over a median portion of the yoke.

In some embodiments, in the basic configuration, the device comprises a transversal track extending horizontally over the tables top surface and secured at opposite ends to fixation means associated with the side of the table. In some embodiments one or more carriages are slidingly translatable along a length of the track are adjustably rotatable about a substantially vertical axis perpendicular to the track. In some embodiments a padded barrier projects laterally from each of the carriages.

In some embodiments a pair of carriages and barriers are used. In some embodiments each carriage comprise a means for locking the carriage in a stable position along the length of the channel. In some embodiments the carriage also includes means for immobilizing the barrier in a desired orientation about a vertical axis. In some embodiments the carriage further comprises a hand-tightenable means for simultaneously operating the means for locking and the means for immobilizing. In some embodiments the track comprises a channel, and the carriage comprises a shuttle slidingly engaged into the channel. In some embodiments the track further comprises a yoke which is secured to the fixation means and supports the channel. In some embodiments the barrier preferably comprises a turn-plate rotatively connected to the shuttle. In some embodiments the means for locking and means for immobilizing comprise a knob having a threaded stem extending axially thereof, passing through a hole in the carriage and screwingly engaging a threaded bore in the shuttle.

In some embodiments, the device for restraining the movement of a body lying over the top surface of an operating table wherein the table includes accessory-mounting rails along the side thereof, comprises a yoke extending horizontally over said surface and being securable at each end to one of the accessory-mounting rails, a channel formed along the yoke, at least one carriage slidingly translatable along lengths of the channel, and a barrier projecting laterally from the carriage.

In some embodiments the carriage comprises a shuttle slidingly engaged into the channel, and said barrier comprises a plate rotatively adjustable about a substantially vertical axis perpendicular to the channel. In some embodiments the carriage further comprises a threaded stem projecting axially from the knob passing through a hole in the plate and engaging a threaded bore in the shuttle. In some embodiments the device preferably includes means for limiting rotational movement of the plate about the vertical axis. In some embodiments the device includes a headrest secured over a median portion of the yoke. In some embodiments the barrier comprises a padded vertical surface. In some embodiments the device does not include any barrier-mounting post or lever extending above the top surface of the table.

### BRIEF DESCRIPTION OF THE DRAWING

FIG. 1 diagrammatically illustrates use of the device according to the invention for bracing and restraining a patient's body lying over the top surface of a longitudinally tilted table;

FIG. 2 diagrammatically illustrates the device used for bracing and restraining a patient's body lying over the top surface of a treatment table having a lateral tilt;

FIG. 3 is a perspective, exploded view of the device;

FIG. 4 is a perspective view of the assembled device; and

FIG. 5 is a perspective view illustrating the use of the device in a shoulder-restraining application.

### DESCRIPTION OF THE PREFERRED EMBODIMENT

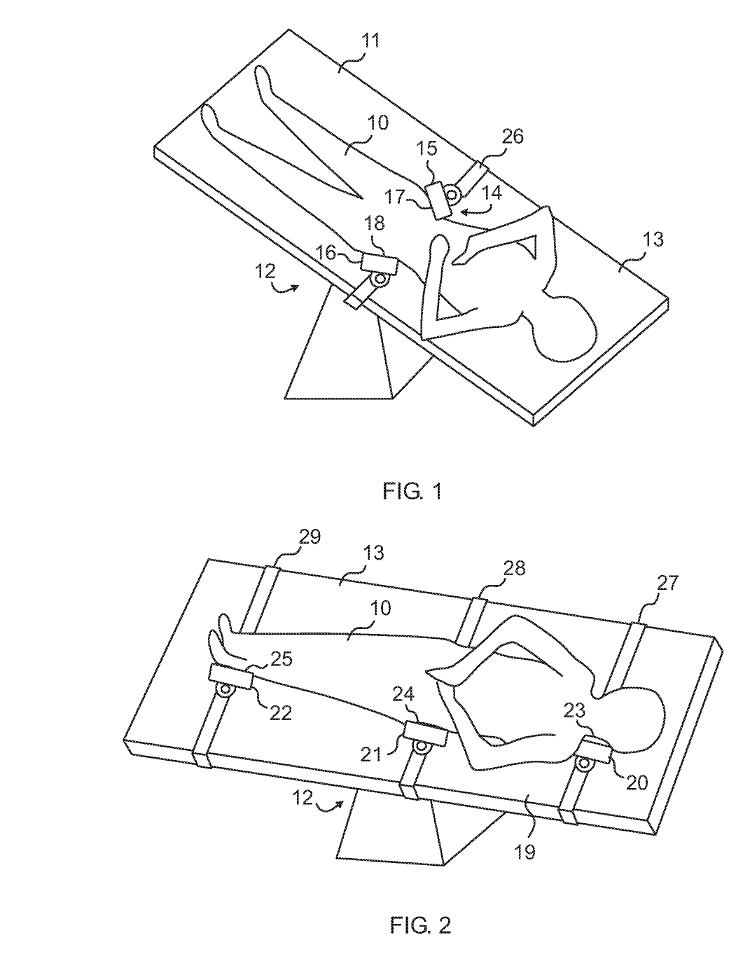

Referring now to the drawing, there is shown in FIG. 1 a patient's body 10 lying upon the top surface 11 of a tiltable table 12 in the Trendelenburg position. The body is restrained from sliding toward the lowered head section 13 of the table by a device 14 according to the invention. The device comprise two padded barriers 15, 16 pressed against the hip regions 17, 18 of the patient.

In FIG. 2, the table 12 is tilted sideways. The patient's body 10 is restrained against sliding toward the lowered left side 19 of the table by three padded barriers 20, 21 and 22 pressing against the patient's side of the nucha 23, the lowered hip 24 and the side of the lowest ankle 25 respectively. In both illustrated cases, the barriers 15, 16, 20, 21, and 22 are adjustably secured on track-mounting yokes 26, 27, 28 and 29 extending transversally over the top surface 11 of the table as will be described below.

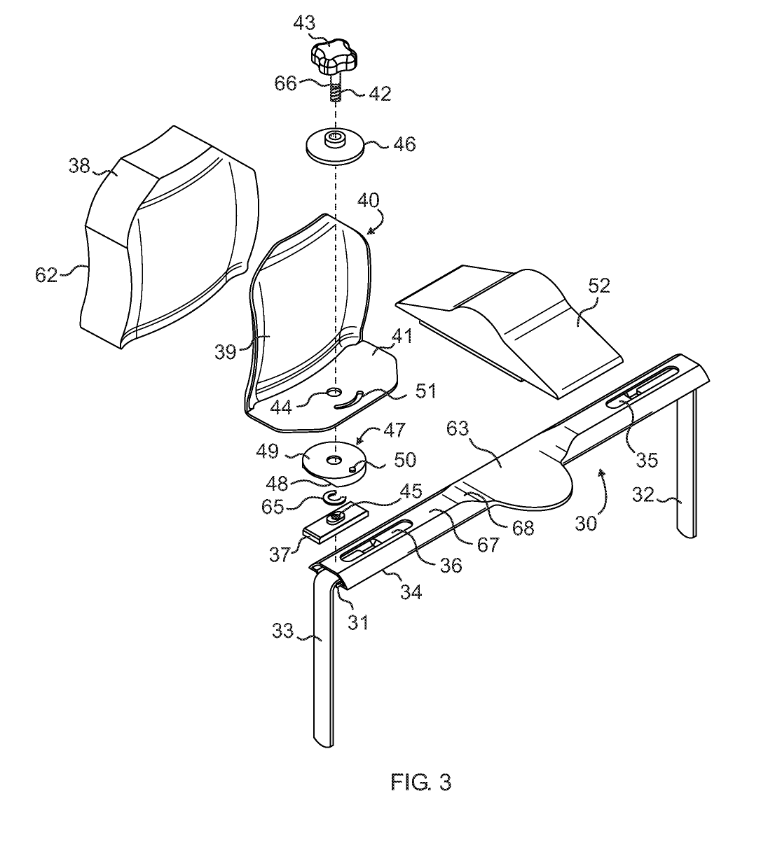

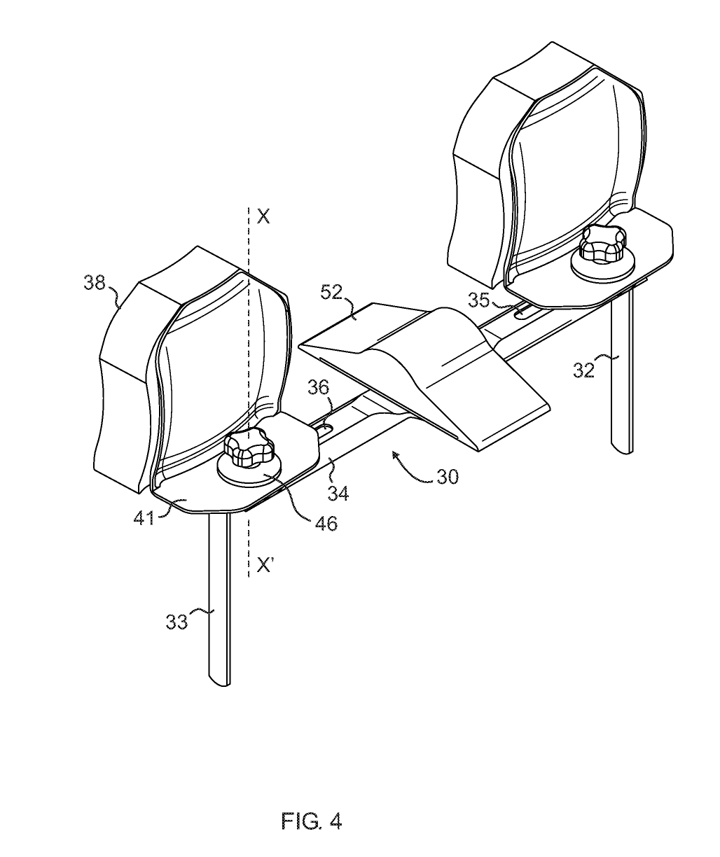

As illustrated in FIGS. 3 and 4, each track-mounting yoke 30 comprises an elongated support member 31 having at each end an angled leg 32, 33. Each angled leg is shaped and dimensioned to be inserted into or attached upon an accessory-support rail (not shown in the FIGURE) that runs along the side of a treatment table.

The support member 31 is surrounded by a sleeve 34 having longitudinal slots 35, 36 cut into its upper wall region 67. The slots 35, 36 form channels into which a shuttle 37 is normally free to slide along the elongated support member 31. It should be understood that one or more channels can alternatively be formed into the support member 31 itself, instead of by means of a sleeve, or by another equivalent means to slidingly hold the shuttle 37.

A padded barrier 38 is attached to the vertical part 39 of an angled bracket 40. A horizontal part 41 of the bracket forms a turn-plate that is rotatively secured to the shuttle 37 through one of the slots 36. This securing is accomplished by a single screw assembly comprising a threaded stem 42 projecting axially from a knob 43, passing through a hole 44 in the center of the turn-plate 41 and engaging a threaded bore 45 in the shuttle 37. The threading of the stem is preferably multi-lead so as to allow for rapid actuation. Alternately, the stem 42 may be secured at its lower extremity to the shuttle 37, then engaged at its upper end through an axial threaded bore in the knob 43.

A hand-tightenable mechanism for simultaneously locking the turn-plate 41 and padded barrier 38 at a desired location along length of the channel-defining sleeve 34 and immobilizing the barrier at a desired orientation about the vertical axis X-X′ perpendicular to the sleeve 34 is enhanced by a skirted washer 46 engaged by the threaded stem 42 and bearing upon the edges of the slot 36.

In order to limit the range of rotation of the barrier about the axis X-X′ a plate 47 comprising a skirt 48 tangentially welded to the edge of a disk 49 is inserted between the turn-plate 41 and the sleeve 34. The skirt 48 bears against the side of the sleeve preventing any rotation of the plate 47. A nib 50 projecting upwardly from the top surface of the disk 49 engages an arcuate slot 51 in the turn-plate. The angular span of the arcuate slot 51 determines the range of rotational orientation of the barrier 38.

The knob 43, stem 42, skirted washer 46, turn-plate 41 and a range-limiting disk 49 of the screw assembly can be prevented from axial separation by a retaining snap ring 65 engaging a radial groove 66 in the stem. In this way, the padded barrier 38 along with its associated bracket 40 and screw assembly can be rapidly removed and replaced as a unitary piece.

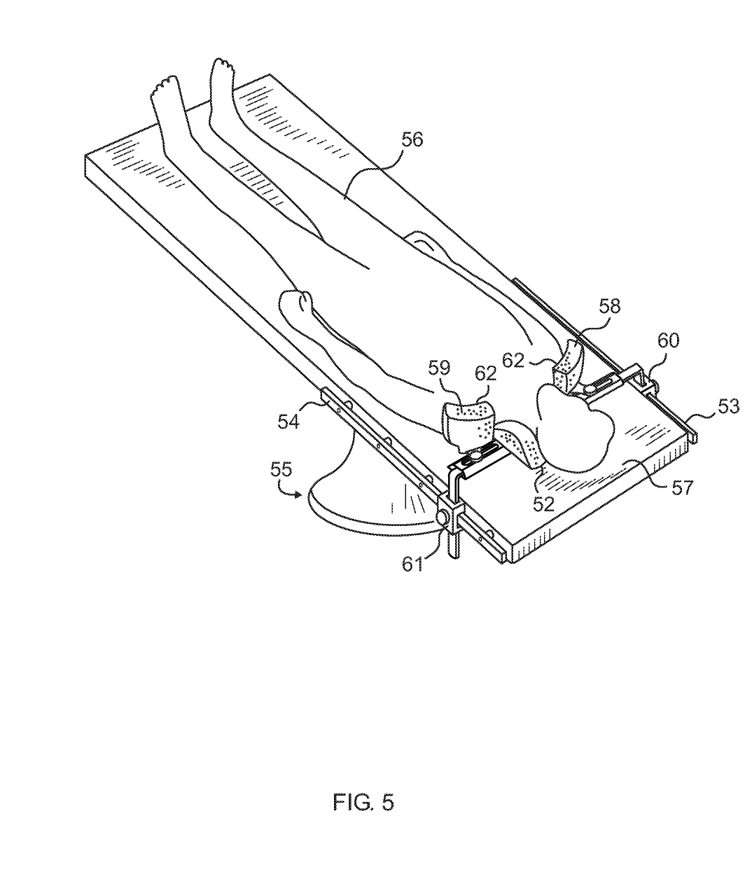

It should be understood that a second barrier and locking mechanism assembly can similarly be mounted through the second slot 35 of the sleeve 34 as shown in FIGS. 4 and 5. The yoke 30 formed by the support member 31 surrounded by the sleeve 34 and bolted to the angled legs 32, 33 can be conveniently secured to the lateral accessory fixation rail 53, 54 that are customarily provided along the sides of a treatment table 55 as shown in FIG. 5.

As illustrated in this FIG. 5, the device is used to restrain movement of the patient 56 toward the lowered head section 57 of the table by positioning the barriers 58, 59 against the patient's shoulders. A padded neck support 52 is conveniently secured with fabric fasteners over a flattened median portion 63 of the yoke in order to support the nucha of the patient. The device is secured to the rails 53, 54 by clamps 60 and 61 customarily associated with the rails. In each embodiment, each barrier presents a padded vertical surface 62 to contact a part of the restrained body.

The total absence of any vertical post or horizontal arm extending substantially above the surface 11 of the table that could interfere with the physician's access to the body should be noted. Further the upper wall region 67 of the sleeve 34 and the flattened median portion 63 present a substantially planar upper surface of the yoke to minimize interference when the barriers are removed. A sloping transition 68 between the upper wall region and the flattened median portion reduces the likelihood of items snagging on the devices as patients and other objects are being repositioned over the table.

While the preferred embodiment of the invention has been described, modifications can be made and other embodiments may be devised without departing from the spirit of the invention and the scope of the appended claims.

What is claimed is:

1. A device for restraining the movement of a body lying over the top surface of a table having lateral fixation means, said device comprising:
a transversal track extending horizontally over said surface and being securable at opposite ends to said fixation means;
at least one carriage slidingly translatable along a length of said track and adjustably rotatable about a substantially vertical axis perpendicular to said track; and
a padded barrier projecting laterally from said carriage.

2. The device of claim 1 which comprises a pair of said carriage and barrier.

3. The device of claim 1, wherein said carriage comprises means for locking said carriage in a stable position along said length.

4. The device of claim 1, wherein said carriage further comprises means for immobilizing said barrier in a desired orientation about said axis.

5. The device of claim 4, wherein said carriage further comprises a hand-tightenable means for simultaneously operating said means for locking and said means for immobilizing.

6. The device of claim 4, wherein said track comprises a channel; and
said carriage further comprises a shuttle slidingly engaged into said channel.

7. The device of claim 6, wherein said track further comprises a yoke secured to said fixation means and fixedly supporting said channel.

8. The device of claim 6, wherein said barrier comprises a turn-plate rotatively connected to said shuttle.

9. The device of claim 8, wherein said means for locking and means for immobilizing comprise:
a knob;
a threaded stem extending axially from said knob, said stem passing through a hole in said carriage and screwingly engaging a threaded bore in said shuttle.

10. The device of claim 8, wherein said threaded stem comprises multi-lead threads.

11. The device of claim 9, which comprises a pair of said carriage and barrier.

12. The device of claim 1, which further comprises a laterally adjustable neck support releasably secured to a median portion of said track.

13. A device for restraining the movement of a body lying over the top surface of an operating table, wherein said table includes an accessory-mounting rail along each side thereof, said device comprising:
a yoke extending horizontally over said surface and being securable at each end to an accessory-mounting rail;
a channel formed along said yoke;
at least one carriage slidingly translatable along a length of said channel; and
a barrier projecting laterally from said carriage.

14. The device of claim 13, wherein said carriage comprises a shuttle slidingly engaged into said channel; and
said barrier comprises a plate rotatively adjustable about a substantially vertical axis perpendicular to said channel.

15. The device of claim 14, wherein said carriage further comprises:
a knob;
a threaded stem projecting axially from said knob, passing through a hole in said plate and engaging a threaded bore in said shuttle.

16. The device of claim 15, wherein said carriage further comprises means for limiting the rotational movement of said plate about said axis.

17. The device of claim 13, which further comprises a headrest secured over a median portion of said yoke.

18. The device of claim 13, wherein said barrier comprises a padded vertical surface.

19. The device of claim 13, in the absence of barrier-mounting posts and levers extending above said top surface.

20. A device for restraining the movement of a body lying over the top surface of a table, said device comprising:
a track extending over said surface and being securable at a first end to said table;
at least one carriage slidingly translatable along a length of said track and adjustably rotatable about a substantially vertical axis perpendicular to said track;
a padded barrier projecting from said carriage; and
an adjustable neck support releasably secured to a portion of said track.

21. A device for restraining the movement of a body lying over the top surface of a table, said device comprising:
a track extending over said surface and being securable at a first end to said table;
at least one padded barrier carriage slidingly translatable along a length of said track and adjustably rotatable about a substantially vertical axis perpendicular to said track; and
wherein said carriage is removable from said track; and,
wherein said track comprises a substantially planar upper surface extending along an entire length of said track.
